(19) United States
(12) Patent Application Publication
(10) Pub. No.: US 2017/0116539 A1
(43) Pub. Date: Apr. 27, 2017

(54) SYSTEM AND METHOD OF PREDICTIVE ANALYSIS

(71) Applicant: Gregory Allen, Greenwich, CT (US)

(72) Inventor: Gregory Allen, Greenwich, CT (US)

(21) Appl. No.: 15/169,795

(22) Filed: Jun. 1, 2016

Related U.S. Application Data
(63) Continuation of application No. 14/918,626, filed on Oct. 21, 2015.

(51) Int. Cl. G06N 7/00; H04L 29/08; H04L 12/24

(52) U.S. Cl. CPC G06N 7/005; H04L 41/0893; H04L 67/22

(57) ABSTRACT

A method of predictive analysis, including the steps of (a) selecting a sequence of discrete information signals for a time interval; (b) identifying one or more creators of the a group the discrete information signals, the one or more creators comprising a first group of social media participants; (c) selecting a group of observers of the sequence of discrete information signals, the observers comprising a second group of social media participants; (d) selecting a sub-group of observers from the group of the observers, the sub-group comprising one or more individuals of the group of observers who have taken external actions subsequent to the time interval; and (e) determining the existence or absence of one or more dependencies between the among the first group and the second group of media participants.

### BACKGROUND OF THE INVENTION

### Field of the Invention

This invention relates generally to the field of predictive analysis and information signal processing and more specifically to the processing of quasi-random information signals for the extraction of meaningful and/or predictive information

Online social media platforms such as Twitter, Facebook, Instagram, various online forums (also called “bulletin boards”), blog and article comment sections and the like are comprised in substantial part of discrete informational signals. These discrete signals are most commonly in the form of content (also called, e.g., “posts”, “tweets”, “submissions”) by participants (also called, e.g., “users” and “members”). It will be understood that while the instant discussion is in the context of such social media platforms, the invention discussed herein may be equally applicable to any source of user generated discrete information signals, for example, as in emails and text messages.

The aforementioned discrete signals may comprise both substantive data and meta-data. Substantive data comprises the participant submitted, substantive content of the signal. In other words, the substantive data comprises the information concerning the topic about which the signal pertains (colloquially, “what the post is about”). For example, substantive data may comprise a participant's opinion and/or factual disclosure on a particular topic such as a consumer product, publicly traded company, political entity or any other topic. It will be understood that a single discrete signal may contain substantive data on a variety of topics, and that the substantive data may be of differing subjective and/or objective quality (i.e., may be characterized by certain populations to be “good information”, “true information”, “misleading information” and like characterizations). The substantive data is often contained in the “body” of the discrete information signal, that is, for example, in the “body” of a “post”.

Meta-data comprises the non-topical information about the discrete information signal, both direct and indirect. Direct meta-data may include, by way of non-limiting example, the signal's creation date and time, origin IP address and/or geographic location, and author. Other meta data may be derived, such as, by way of non-limiting example, the level of activity of the user, the current, median, mean, greatest and least length of the user's posts, the current, median, mean, greatest and least level of responsive activity to the user's posts, and the like.

In this framework, various prior art systems have sought to analyze and extract useful information from substantive data and/or meta data from discrete information signals of social media. In general, these prior art systems analyze social media content in the form of discrete information signals such as posts and seeks to determine the existence of and/or identify trends in such signals.

One example of such a prior art system is the service provided at the domain <needtagger.com> examines “social signals” contained in social media signal sequences (also called “streams”) to identify content trends in the sequence of signals. For example, certain such prior arts systems employed natural language filters to identify populations of users on social media sites relevant to one or more providers of good of services (in other words, for these entities to identify customers) based on trends and/or substantive content in sequences of discrete information signals in social media.

Another example of such prior art systems is that found at <leadsift.com>. This prior art system analyzes sequences of discrete information signals on social media to seek to identify “buying signals”, that is, user content in the form of posts that may indicate to sellers of goods or services a propensity of for purchase of such goods or services by such users (i.e., again to identify potential customers). Such prior art systems further provide “actionable insights” and “audience segmentation” information, as well as information on competitors of the goods and service providers based on trends in content contained in sequences of discrete information signals.

Yet another example of such prior art systems is found at <socedo.com>. This prior art system analyzes sequences of discrete information signals on social media to generate sales leads based on trends in the substantive content of such sequences of signals.

These prior art systems, including other similar social media filters and analyzers presently known, focus strictly on the content of what is being said (i.e., on the content of the discrete information signals), but not such signals and signal content relate to substantively to the external context. As will be described more fully below in relation to preferred embodiments of the instant invention, the instant invention concerns a method and system for analyzing social media content, i.e., the discrete information signals or “posts” contained in such social media to make, unlike the aforementioned prior art, predictive determinations of external effects (i.e., “real world outcomes”) of such discrete information signals by determination of underlying states of dependency between such signals and external contexts.

### SUMMARY OF THE INVENTION

As will be described more fully in the description of preferred embodiments, the present invention may include a method of predictive analysis, including the steps of (a) selecting a sequence of discrete information signals for a time interval; (b) identifying one or more creators of the a group the discrete information signals, the one or more creators including a first group of social media participants; (c) selecting a group of observers of the sequence of discrete information signals, the observers including a second group of social media participants; (d) selecting a sub-group of observers from the group of the observers, the sub-group including one or more individuals of the group of observers who have taken external actions subsequent to the time interval; and (e) determining the existence or absence of one or more dependencies between the among the first group and the second group of media participants.

In some embodiments, step (e) above may comprise the step of determining the existence or absence of one or more dependencies between the discrete information signals created by the first group of social media participants and the external actions of the second group of media participants. Likewise, step (d) may comprise the step of identifying from the first and second groups of social media participants social media participants social media participants of interest.

In other embodiments of the present invention, the participants of interest may comprise participants having a statistically significant effect on the external actions. Also, aforementioned step (a) may include the step of identifying a subject of interest and the discrete information signals concern the subject of interest.

Yet other embodiments of the present invention may include the additional steps to determine probability distributions of external actions based on a relationship between (1) reactive data and (2) social activity and observing participants.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

### DESCRIPTION OF THE PREFERRED EMBODIMENTS

The operation of the present invention may be understood by way of illustrative, non-limiting examples, such as the following.

A discrete information signal may be a submission (e.g., a “post”) to an online discussion forum concerning any topic of interest by any participant of such forum. Alternatively, the discrete information signal may be a “tweet” to the information service Twitter, a post to the social media site FaceBook, or any similar content to any similar service.

The post (which will be understood herein to include alternatively other similar submissions such as the aforementioned “tweets”, FaceBook posts and the like) may be authored for example by “User A”, having an IP address B in city and state C. It may have a body comprising the text “I see that Company Y is releasing new Product Z next week. I think Product Z is going to be an excellent product.” The foregoing body text would thus comprise the substantive data of the discrete information signal (i.e., of the post). “User A”, IP address B and city and state C would comprise portions of the post's meta-data. Other meta data may be derived. For example, it may be derived that “User A” has median post (body) length of 57 words, has a median daily post count of 7, and has a median response count (i.e., the median number of other users' posts made in response to User A's posts) of 12.

It will be understood that the distribution of such discrete information signals is quasi-randomly distributed, both within particular social media contexts and across disparate social media contexts.

Certain embodiments of the present invention provide a method of analysis of discrete information signals such as those previously described for the purpose of identifying discrete information signals and/or participants (i.e., authors of such signals) who are particularly relevant to pre-selected subject matter of interest in quasi-randomly distributed social networks. Embodiments of the present invention further provide a method of predicting activity or effects in an external context based on an analysis of the aforementioned discrete information signals (i.e., to a method for analyzing social network content and predicting outcomes therefrom). Finally, embodiments of the present provide a method for predicting a participant's behavior from discrete information signals in a social network. It will be understood that as used herein, “external contexts” and “outside of the social media context” refer generally to “real world” contexts, i.e., “real world” effects and outcomes.

In general terms, certain embodiments of the present invention comprise the following steps.

First is created a first list of discrete information signals (posts), from a particular point in time or time interval, the discrete information signals concerning a pre-selected subject. This first list thus comprises participants in one or more social networks who have referenced the subject of concern in their posts, most particularly, in the actual data (body) of the posts. This entails isolating a specific grouping from the one or more social networks according to the particular subject of concern. As will be discussed in more detail below, embodiments of the present invention differ from the prior art, inter alia, in that once these embodiments of the present invention isolates a specific grouping of signals (e.g., of people/messages) based on a particular subject of concern, it also begins looking for a dependency between such signals and one or more external contexts.

The pre-selected subject may be, for example, anything which actual data may address, such as consumer products, publicly traded companies, political entities, specific or general financial news, popular TV, music, fashion, and the like. The pre-selected subject typically yields a large (or effectively infinite) sequence of discrete information signals, which may be denoted as

s≡{sₜ}ₜ₌₁^{∞}

where S denotes all such infinite sequences of discrete information signals (posts). The sequence may be, for purposes of non-limiting example, all activity on Twitter that is or may happen and may be as broad as “all topics under discussion”, more specifically addressing broad topics such as “finance”, “politics”, “fashion”, “food”, “music”, etc., or as narrow as or narrower than “all discussions concerning political candidate X” or any other scope.

Second is created a second list of participants in the one or more social networks for the particular time interval who have observed those senders of messages who have mentioned the subject of concern (“observing participants”) and who appear to have had some activity as a result of such observation. In other words, the second list of participants comprises participants who have responded to one or more of the posts contained in the first list, presumably after reading at least a portion of such post or posts.

Together, application of the first and second steps yield a sequence of discrete information signals, comprising social media activity at any moment or interval of time. The sequence (and the consequential function/expression of the sequence of signals) consists of participants producing tangible activity in the form of discrete information signals having actual data, and participants observing that activity. This may be called the “initial state” and may be represented with a probability expression created with the use of Bayes Theorem, from which the posterior (i.e., future) belief of individual i about subject θ after observing the first n signals of

{sₜ}ₜ₌₁ⁿ

as follows:

φₙⁱ(s)= [symbol] ⁱ(θ=A|{sₜ}ₜ₌₁ⁿ)

The initial state may comprise, in part, for example, a list of all relevant “Twitter handles” (i.e., a list of identifiers of all Twitter participants) addressing the topic of interest during the period in question. The list may be, for example, all the people “tweeting” (i.e., posting messages) about a specific company or a product or a song or any other topic. This list can be generated in real time for current information or as a test for anticipating impact of such sequence of signals on effects on external contexts.

Third is created a sub-list of those participants in the one or more social networks who are particularly relevant with respect to the subject of concern from the first and second lists for the pre-selected time interval. The relevance may reflects those participants that are connected more robustly with each other and with respect to other factors that are more closely associated with the subject matter of concern. For example, those other factors may include those who are also connected to other websites associated with the subject matter of concern, those whose livelihood is associated with the subject matter of concern, or those with an emotional attachment to the subject matter of concern.

Stated differently, one may assume or consider the possibility of “underlying state(s) of dependency”; that is, considering all participants producing and observing actual data, there exists a sub-set of such participants which reflects the way the broader population are both viewing and relating to this actual data (and the subject matter of it). Mathematically, this may be defined for an underlying state θ={A, B} (the underlying state so defined because an exchangeable process such as the series of discrete information signals generates a sequence in which order is not relevant) as

rₙ(s)≡ [symbol] {t≦n|sₜ=a}

In other words, the important parameter is the number of times sₜ=a in the first n discrete information signals. Furthermore, by the strong law of large numbers rₙ(s)/n converges to some pε[0,1], thus permitting the definition of the set as

S̅≡{sεS:lim_{n→∞}rₙ(s)/n exists}

At this stage, the preferred embodiment of the instant invention may be analyzing not the substantive context of the discrete information signals (i.e., of the substantive content of the posts), but instead on the identity of and relationship between the participants. It will be understood the aforementioned identities and relationships need not be complete, that is, they may not identify, for example, a specific person or a “real world” relationship such as co-worker, family member, etc., but need only be some cognizable identifier and relationship such as, for example, User ID X, User ID Y, with a relationship of “followers”.

Alternatively, in more generally applicable terms, the foregoing could be understood as a social network diagram with corresponding connectivity to external information. In this context, embodiments of the instant invention could list, for some one interested in Company X, for example, a participant-limited list (i.e., a participant-limited sub-list) within a subset of an original topic search, e.g, limited to participants comprising one or more of securities traders, news correspondents, bloggers, critics, artists and the like. It will be appreciated that the category (i.e., types) of participants in such participant-limited lists may be selected based on users' understanding of which group or groups would be most relevant to the topic of interest For example, participant-limited lists may be limited to those participants whom have livelihoods that are affected by the information of interest, who may have emotional attachments to the information, or any other identifiable connection to the topic of interest.

Fourth, the previously described sub-list is analyzed to determine the existence or absence of one or more dependencies among the relationships of the participants in the sub-list. By doing so, the analysis may predict future activity among these participants. This analysis may be recursive so as to refine these interrelationships among the identified participants to facilitate the prediction of the impact of such participants on external context data. The analysis may also identify other aspects of the discrete information signals, such as frequency of certain terms of interest (for example, references to “Company X”), and qualitative aspects of the discrete information signals (for example, whether the sentiment is positive, or negative, or something else). Repeated, previously un-identified key words may also be determined at this step by analysis of the discrete information signals.

Important to the present invention is the presumption that social media has an effect on events outside of the social media context, that is in external contexts.

Based on this presumption, embodiments of the present invention may assign a prior probability between 0 and 1 to the existence of one or more underlying states within the larger sequence of discrete information signals correlated to the so-called “real world” outcomes. With signals sₜε{a, b}, the underlying state defined as θ={A, B} and participant i, a prior probability τⁱε(0, 1) may be assigned to the outcome θ=A. Specifically, assuming that each [symbol] ⁱ for any given distribution Z, there exists a probability of 1 on \hat{p}ₑ for some \hat{p}ₑ>0.5; that is, [symbol] ⁱ (\hat{p}ₑ)=1 and [symbol] ⁱ (p)=0 for each p<\hat{p}ₑ. As a result, (i) there is asymptotic learning of the underlying state in that

[symbol]

ⁱ(lim_{n→∞}φₙⁱ(s)=1|θ=A)=1

and (ii) there is asymptotic agreement between the two agents in the sense that

[symbol]

ⁱ(lim_{n→∞}|φₙ¹(s)−φₙ²(s)|=0)=1

Fifth, with the foregoing understood, embodiments of the present invention may refine the initial state as determined in the second step above (the second step comprising a sequence of discrete information signals, i.e., a series of “posts”) to reveal underlying state(s) of dependency. In other words, embodiments of the present invention may perform the foregoing analysis to determine states of dependency which may underlie a sequence of discrete information signals. This may be achieved by adapting the initial state function (i.e., the function used to describe and/or define the initial state) to include the identified prior probability or probabilities and identified state or states of dependency. The state of dependency may become realized through a refining of social media content while identifying a connection (if one exists) to external data (i.e., to an external context).

The refinement just described may be described as follows, it is understood from the previous steps that [symbol] ⁱ(sεS̅)=1 for i=1, 2. Therefore, through an application of Bayes theorem,

$${φ}_{n}^{i} ( s ) = \frac{1}{1 + \frac{1 - {τ}^{i} ( {r}_{n} \vert θ = B )}{{τ}^{i} ( {r}_{n} \vert θ = A )}}$$

At this juncture, preferred embodiments of the present invention may yield a sub-list of participants considered to by “high impact” participants, that is, participants whose posts are significantly associated with external context effects on the topic or topics of interest. For example, the sub-list be a list of certain Twitter handles (i.e., participant identities), discussing Company X, all of whom are finance professionals (or possibly finance professionals associated with Company X). The related external data could be, for example, a percent increases in trading volume above the average, increased volatility of share value, or any other such effect. These percent increases of trading volume, for example, may inform users of the present invention the exact (or potential) impact of a particular sequence of one or more discrete information signals (i.e., a series of “tweets” or posts), which may be considered in some contexts to reflect a sentiment on the topic of interest.

Alternatively, the sub-list and external effect could be anything, for example, comprising high impact participants such as fashion bloggers with the associated data being increased web traffic on a particular fashion business portal or projected sales volume. It will be understood that there exist countless variations of high impact participants and external effects (i.e., external contexts).

The presentation of the aforementioned result can be technical or non-technical, depending on the target audience of the information generated. For example, a non-technical version may show sentiment in the form of a facial expression or qualitative description, while more technical versions could be seen as quantitative data, graphical representations or spreadsheets.

In certain embodiments of the present invention, a second portion of the disclosed system my work in conjunction with the first portion previously described, the second portion improving the accuracy of the predictive capabilities of the system and/or reinforcing the relationship between the discrete information signals (e.g., the “posts”) and the effects such signals have outside of the social media context, i.e., in an external context. It will be understood that these parameters may be analyzed to determine probability distributions in order to further understand the relationship between the discrete information signals and the effects of such signal son the external context, not necessarily based on their relationship. In such embodiments, the system may identify three variables, namely, social media activity, observing participants comprising in whole or part the underlying state of states of dependency, and reactive data, i.e., data concerning the effects, outside the context of the social media, of the sequence of discrete information signals. These variables are then analyzed to determine probability distributions based on the relationship between reactive data on the one hand and social activity and observing participants on the other hand. This relationship may be formulated as Y=ZX, where Y relates to the reactive data, X relates to the social activity and Z relates to the observing participants.

In these embodiments, the distribution of Y may be first determined following

$$\begin{matrix}{ℱ}_{Y} ( b ) = \{ Y \leq b \} \\ = \{ Y \leq b and Z = 1 \} + \{ Y \leq b and Z = - 1 \} \\ = \{ X \leq b and Z = 1 \} + \{ - X \leq b and Z = - 1 \}\end{matrix}$$

Because X and Z are independent, the equation may be formulated as

$$\begin{matrix}\begin{matrix} \{ X \leq b and Z = 1 \} + \\ \{ - X \leq b and Z = - 1 \}\end{matrix} = \{ Z = 1 \} * \\ \{ Z = - 1 \} * \{ - X \leq b \} \\ = \frac{1}{2} * \{ X \leq b \} + \frac{1}{2} * \{ - X \leq b \}\end{matrix}$$

Furthermore, because X is a standard normal random variable, −X is also a standard normal random variable, and so [symbol] {X≦b}= [symbol] {−X≦b}=N(b). Thus, [symbol] _{Y}(b)=N(b), and so Y is a standard normal random variable.

Further in these embodiments, as the system strengthens the relationships as described, the system may begin to analyze the relationships in terms of expectations, (i.e., what would happen if the variables are dependent). This strengthening of relationships confirms causality because it provides a mathematical argument for the future dependency of the variables (i.e., future information). In other words, an observer may observe a relationship between two seemingly random events, but if the random event are in fact affecting each other, then they will obey certain laws of probability pertaining to random variables.

Assuming [symbol] X= [symbol] Y=0, the covariance of X and Y is COV(X,Y)= [symbol] [XY]= [symbol] [ZX²] Furthermore, because Z and X are independent, so are Z and X̂2, thus yielding the factoring [symbol] [zX²]= [symbol] z* [symbol] [X²]=0*1=0. This confirms that X and Y are uncorrelated, although they may still be presumed to be dependent.

Finally, the foregoing expressions may be combined to further confirm the dependency of the effect of the external context of the information signals. In this regard, the narrowed sequence information signals (i.e., social media activity) may be confidently confirmed to be bound to external context events via one or more observers of the signals who engage in the external context. It will be understood that the identity of the one or more observers need not be known or determined, nor specifically which of the information signal such observers have observed, nor specifically how such observers are acting in the external context; that is, it is sufficient that once the predictive cause-effect relationship has been determined without need for such specificity of determination.

Mathematically, the foregoing may be considered as follows. X and Y cannot be independent because if they were, then the functions of X and Y would also be independent, as in:

[symbol]

{|X|≦1,|Y|≦1}= [symbol] {|X|≦1}=N(1)=N(−1)

and

[symbol]

{|X|≦1}* [symbol] {|Y|≦1}=(N(1)−N(−1))²

These two expressions are not equal, however, and so X and Y are not independent. Thus, one may determine the existence of the cumulative distribution [symbol] _{X,Y}(a,b). This may be determined as follows:

$$\begin{matrix}= \{ X \leq a and Y \leq b \} \\ = \{ X \leq a , X \leq b , and Z = 1 \} + \{ X \leq a , - X \leq b , and Z = - 1 \} \\ = \{ Z = 1 \} * \{ X \leq min ( a , b ) \} + \{ Z = - 1 \} * \{ - b \leq X \leq a \} \\ = \frac{1}{2} N ( min ( a , b ) ) + \frac{1}{2} max \{ N ( a ) - N ( - b ) , 0 \}\end{matrix}$$

Dependency may be further confirmed by confirming that absence of a joint density function for the two variables of the form:

$${ℱ}_{X , Y} ( a , b ) = {\int }_{- ∞}^{a} {\int }_{- ∞}^{b} {f}_{X , Y} ( x , y ) d y d x for all a ε , b ε$$

Embodiments of the present invention may utilize the foregoing to assign a value determined by the percent increases or decreases in the volume of selected information signals in order to quantify the sentiment inherent in and/or impact to an external context of the information signals. It will be appreciated that such quantification might not necessarily determine qualitatively whether the inherent sentiment is “good” or “bad”, but may determine the degree of such sentient and thus the predicted impact of such information signals (and the sentiment inherent therein) on one or more external contexts.

Embodiments of the present invention may be configured to repeat the foregoing process on sequences of information signals for pre-identified participants in order to monitor, predict and analyze on an ongoing basis effects of such information signals on an external context, that is, of such social media content on an external context.

While the foregoing discussion of preferred embodiments concerned discrete information signals principally in the form of social media posts, it will be understood that the instant invention is not limited to such content (i.e., not limited to social media platforms). Because the instant invention concerns principals of social networking dynamics (how people interact), embodiments may address any situation involving complex interpersonal relationships. By way of further, non-limiting example, business human resource departments may use embodiments of the present invention to run one or more simulations based on historical human resource data to yield potential success paths for employees. Another non-limiting example concerns industry, namely, where a business entity were looking to enter a new market or industry and wanted to understand how the entity's entry would affect the dynamics of the existing market. In such cases, embodiments of the present invention can be implemented up to run a simulation of this scenario to predict cause effect relationships between the entry in the marketplace and the effects of such entry on the marketplace.

Although the particular embodiments shown and described above will prove to be useful in many applications in the art to which the present invention pertains, further modifications of the present invention will occur to persons skilled in the art. All such modifications are deemed to be within the scope and spirit of the present invention as defined by the appended claims.

1-14. (canceled)

15. A method of predictive analysis, the method comprising:
(a) selecting, via a processor, a sequence of discrete information signals for a time interval;
(b) identifying, via the processor, based on the selecting the sequence, one or more creator identifiers associated with said sequence of discrete information signals, wherein said one or more creator identifiers comprises a first group of social media participant identifiers;
(c) selecting, via the processor, based on the selecting the sequence, a group of observer identifiers associated with said sequence of discrete information signals, wherein said observer identifiers comprise a second group of social media participant identifiers;
(d) selecting, via the processor, a sub-group of observer identifiers from said group of said observer identifiers, wherein said sub-group comprises one or more individual identifiers of said group of observer identifiers, wherein the one or more individual identifiers have taken an external action subsequent to said time interval, wherein the selecting comprises identifying, via the processor, from said first and second groups of social media participant identifiers, a social media participant identifier of interest, wherein said participant identifier of interest comprises a participant having a statistically significant effect on said external action;
(e) determining, via the processor, an existence or an absence of one or more dependencies between said first group and said second group; and
(f) storing, via the processor, a datum informative of the existence.

16. The method of claim 15, wherein the step (e) comprises determining, via the processor, the existence or the absence of the one or more dependencies between the sequence of discrete information signals traced to said first group of social media participant identifiers and said external action associated with said second group of media participant identifiers.

17. The method of claim 16, wherein the step (a) comprises identifying, via the processor, a topic of interest, wherein said sequence of discrete information signals concern said subject of interest.

18. The method of claim 17, further comprising:
generating, via the processor, a predictive analysis data of a future external action based on the existence of said one or more dependencies between said first group and said second group of media participant identifiers as identified in the datum based on the storing.

19. The method of claim 18, further comprising:
determining, via the processor, a probability distribution of external actions based on a relationship between (1) a reactive data and (2) a social activity and an observation datum informative of observing participant identifiers.

20. A method of predictive analysis, the method comprising
(a) selecting, via a processor, a sequence of discrete information signals for a time interval based upon a predetermined topic of interest;
(b) identifying, via the processor, based on the selecting the sequence, one or more creator identifiers associated with said sequence of discrete information signals, wherein said one or more creator identifiers comprises a first group of social media participant identifiers;
(c) selecting, via the processor, based on the selecting the sequence, a group of observer identifiers associated with said sequence of discrete information signals, wherein said observer identifiers comprise a second group of social media participant identifiers;
(d) selecting, via the processor, a sub-group of observer identifiers from said group of said observer identifiers, wherein said sub-group comprises one or more individual identifiers of said group of observer identifiers, wherein the one or more individual identifiers have taken an external action subsequent to said time interval;
(e) determining, via the processor, an existence or an absence of one or more dependencies between said first group and said second group;
(f) storing, via the processor, a datum informative of the existence; and
(g) generating, via the processor, a predictive analysis data of a future external action based on the existence of said one or more dependencies between said first group and said second group of media participant identifiers as identified in the datum
(h) selecting, via the processor, one or more individual identifiers from said group of observer identifiers of said sequence of discrete information signals; and
(i) predicting, via the processor, the future external action associated with said one or more individual identifiers based upon a current observation of discrete information signals for said time interval concerning said predetermined topic of interest, wherein said current observation of discrete information signals is associated with said one or more individual identifiers, wherein said social media participant identifier of interest comprises a participant having a statistically significant effect on said external action.

21. The method of claim 20, wherein the step (e) comprises determining, via the processor, the existence or the absence of the one or more dependencies between the sequence of discrete information signals traced to said first group of social media participant identifiers and said external action associated with said second group of media participant identifiers.

22. The method of claim 21, wherein the step (d) comprises identifying, via the processor, from said first and second groups of social media participant identifiers, a social media participant identifier of interest.

23. The method of claim 22, further comprising:
determining, via the processor, a probability distribution of external actions based on a relationship between (1) a reactive data and (2) a social activity and an observation datum informative of observing participant identifiers.

24. A method of predictive analysis, the method comprising:
(a) selecting, via a processor, a sequence of discrete information signals for a time interval;
(b) identifying, via the processor, based on the selecting the sequence, one or more creator identifiers associated with said sequence of discrete information signals, wherein said one or more creator identifiers comprises a first group of social media participant identifiers;
(c) selecting, via the processor, based on the selecting the sequence, a group of observer identifiers associated with said sequence of discrete information signals, wherein said observer identifiers comprise a second group of social media participant identifiers;
(d) selecting, via the processor, a sub-group of observer identifiers from said group of said observer identifiers, wherein said sub-group comprises one or more individual identifiers of said group of observer identifiers, wherein the one or more individual identifiers have taken an external action subsequent to said time interval, wherein the selecting comprises identifying, via the processor, from said first and second groups of social media participant identifiers, a social media participant identifier of interest, wherein said social media participant identifier of interest comprises a participant having a statistically significant effect on said external action;
(e) determining, via the processor, an existence or an absence of one or more dependencies between said first group and said second group based on the existence or the absence of the one or more dependencies between the sequence of discrete information signals traced to said first group of social media participant identifiers and said external action associated with said second group of media participant identifiers;
(f) storing, via the processor, a datum informative of the existence;
(g) determining, via the processor, a probability distribution of external actions based on a relationship between (1) a reactive data and (2) a social activity and an observation datum informative of observing participant identifiers.

25. The method of claim 24, wherein the step (a) comprises identifying, via the processor, a topic of interest, wherein said sequence of discrete information signals concern said subject of interest.

26. The method of claim 25, further comprising:
generating, via the processor, a predictive analysis data of a future external action based on the existence of said one or more dependencies between said first group and said second group of media participant identifiers as identified in the datum.

27. The method of claim 26, wherein the step (a) comprises selecting, via the processor, said sequence of discrete information signals for said time interval based upon a predetermined topic of interest.

28. The method of claim 27, further comprising:
(h) selecting, via the processor, one or more individual identifiers from said group of observer identifiers of said sequence of discrete information signals; and
(i) predicting, via the processor, the future external action associated with said one or more individual identifiers based upon a current observation of discrete information signals for said time interval concerning said predetermined topic of interest, wherein said current observation of discrete information signals is associated with said one or more individual identifiers.
